(19) United States
(12) Patent Application Publication
(10) Pub. No.: US 2025/0216858 A1
(43) Pub. Date: Jul. 3, 2025

(54) UNMANNED AERIAL VEHICLE CONTROL METHOD AND APPARATUS, AND COMPUTER DEVICE AND STORGE MEDIUM

(71) Applicant: Arashi Vision Inc., Shenzhen (CN)

(72) Inventors: Luochuan LI, Shenzhen (CN); Xionglin WU, Shenzhen (CN); Ran AN, Shenzhen (CN); Yibin GUO, Shenzhen (CN)

(73) Assignee: Arashi Vision Inc., Shenzhen (CN)

(21) Appl. No.: 19/086,014

(22) Filed: Mar. 20, 2025

Related U.S. Application Data
(63) Continuation of application No. PCT/CN2023/122766, filed on Sep. 28, 2023.

(30) Foreign Application Priority Data
Sep. 20, 2022 (CN) 202211142840.2

(51) Int. Cl. G05D 1/49; B64U 10/13; G05D 1/46; G05D 109/25

(52) U.S. Cl. CPC G05D 1/49; G05D 1/46; B64U 10/13; B64U 2201/20; G05D 2109/254

(57) ABSTRACT

A method for controlling an unmanned aerial vehicle (UAV) may comprise obtaining an instruction for controlling the UAV; detecting that the instruction is a preset instruction for a flight action; and controlling the UAV to move in the flight action according to the preset instruction. The instruction may include a first instruction configured to control the UAV to perform a dive action in a diving attitude autonomously or a second instruction configured to control the UAV to perform the dive action according to a received direction control instruction.

### CROSS REFERENCE TO RELATED APPLICATIONS

The present application is a continuation of International Application No. PCT/CN2023/122766, filed Sep. 28, 2023, which claims priority of Chinese Patent Application No. 202211142840.2, filed Sep. 20, 2022, the entire content of both of which being incorporated herein by reference in its entirety.

### TECHNICAL OF FIELD

The present application relates to the field of unmanned aerial vehicle (UAV) technology, and in particular to a UAV control method, device, computer equipment, storage medium and computer program product.

### BACKGROUND

With the development of UAV technology, more and more actions can be performed by controlling a UAV, and the representative action among these actions is a large-scale dive of the UAV towards the ground. These actions can only be achieved when the UAV has high flexibility.

In traditional technology, the flexibility of a UAV is positively correlated with a thrust-to-weight ratio of the UAV, which is a ratio of a maximum thrust of an aircraft to its own weight. However, the thrust-to-weight ratio is determined by a hardware structure of the UAV, and it is difficult to increase the flexibility of UAV control through some means at a software level.

### SUMMARY

Based on this, it is necessary to provide a UAV control method, device, computer equipment, computer-readable storage medium and computer program product that can increase the flexibility of the UAV in response to the above-mentioned and other technical problems.

In a first aspect, a method for controlling an unmanned aerial vehicle (UAV) may comprise obtaining an instruction for controlling the UAV; detecting that the instruction is a preset instruction for a flight action; and controlling the UAV to move in the flight action according to the preset instruction. The instruction may include a first instruction configured to control the UAV to perform a dive action in a diving attitude autonomously or a second instruction configured to control the UAV to perform the dive action according to a received direction control instruction.

In a second aspect, a UAV comprises a power assembly; and one or more processors, operating individually or in coordination, configured to control an operation of the power assembly to control an attitude of the UAV to flip along a first axis so that the UAV enters a diving attitude; and control the attitude and/or flight direction of the UAV to move in a dive action according to a received direction control instruction, wherein a magnitude of a descending acceleration of the UAV along a direction of gravity is related to the attitude and the flight direction of the UAV, and during moving in the dive action, the UAV is shielded from the throttle instruction

In a third aspect, a somatosensory controller includes an attitude sensor configured to obtain an attitude of the somatosensory controller; and one or more processors, operating individually or in coordination, configured to control an UAV to control an attitude of the UAV to flip along a first axis so that the UAV enters a diving attitude; and control the attitude and/or flight direction of the UAV to move in a dive action according to a received direction control instruction, wherein a magnitude of a descending acceleration of the UAV along a direction of gravity is related to the attitude and the flight direction of the UAV, and during moving in the dive action, the UAV is shielded from the throttle instruction.

In a fourth aspect, the present application also provides a UAV control apparatus. The apparatus comprises circuitry configured to obtain instruction for controlling a UAV, the instruction indicating a pitch angle, a throttle amount, and/or a heading angle; and detect whether the instruction is a preset instruction for a flight action; and in a case that it is detected that the pitch angle and the throttle amount indicated by the instruction exceed a pitch angle threshold and a throttle amount threshold respectively, the circuitry is further configured to control an attitude of the UAV according to the heading angle and the throttle amount indicated by the instruction; determine an acceleration rate of the UAV according to the throttle amount and the attitude; determine a target direction based on the pitch angle and the heading angle; adjust a speed of the UAV according to the acceleration rate and the target direction to obtain an adjusted speed of the UAV; and control the UAV to perform the flight action according to the attitude and the adjusted speed.

In a fifth aspect, the present application further provides a computer device. The computer device comprises at least one memory and at least one processor, wherein the at least one memory stores a computer program, and the at least one processor, when executing the computer program, is configured to obtain instruction for controlling a UAV, the instruction indicating a pitch angle, a throttle amount, and/or a heading angle; and detect whether the instruction is a preset instruction for a flight action, and in a case that it is detected that the pitch angle and the throttle amount indicated by the instruction exceed a pitch angle threshold and a throttle amount threshold respectively, the at least one processor is further configured to control an attitude of the UAV according to the heading angle and the throttle amount indicated by the instruction; determine an acceleration rate of the UAV according to the throttle amount and the attitude; determine a target direction based on the pitch angle and the heading angle; adjust a speed of the UAV according to the acceleration rate and the target direction to obtain an adjusted speed of the UAV; and control the UAV to perform the flight action according to the attitude and the adjusted speed.

In a sixth aspect, the present application further provides a computer-readable storage medium having a computer program stored thereon, and when the computer program is executed by a processor, the steps of controlling the UAV in one of the embodiments of the present disclosure are implemented.

The above-mentioned UAV control method, apparatus, computer device, storage medium and computer program product obtain instruction for controlling a UAV; detect whether the instruction is preset instruction for a flight action; if the instruction is detected to be the preset instruction, control the UAV to move with the flight action according to the instructions. Thus, the instruction is pre-set for the flight action, and the instruction for controlling the UAV is detected according to the preset instruction to determine whether operation corresponding to the flight action is triggered, and then in the control mode of the flight action, the UAV is controlled to perform corresponding flight action according to the instruction; so as to improve flexibility of the UAV. This flexibility can be reflected in aspects such as attitude control maintenance, flight speed direction tracking, and large-scale attitude changes.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is an application environment diagram of a UAV control method in an embodiment;

FIG. 2 is a flow chart of a UAV control method in an embodiment;

FIG. 3 is a schematic diagram of a somatosensory controller in an embodiment;

FIG. 4 is a schematic diagram of a somatosensory controller coordinate system in an embodiment;

FIG. 5 is a schematic diagram of a somatosensory controller adjusting a pitch angle in an embodiment;

FIG. 6 is a schematic diagram of a somatosensory controller adjusting a heading angle in an embodiment;

FIG. 7 is a schematic diagram of a somatosensory controller adjusting a throttle amount in an embodiment;

FIG. 8 is a schematic diagram of a somatosensory controller controlling a UAV in an embodiment;

FIG. 9 is a structural block diagram of a UAV control apparatus in an embodiment;

FIG. 10 is a structural block diagram of a UAV control apparatus in an embodiment;

FIG. 11 is an internal structural diagram of a computer device in an embodiment.

### DETAILED DESCRIPTION

In order to make the purpose, technical solution and advantages of the present application more clearly understood, the present application is further described in detail below in conjunction with the accompanying drawings and embodiments. It should be understood that the specific embodiments described herein are only used to explain the present application and are not used to limit the present application.

In order to make the purpose, technical solution and advantages of the present application more clearly understood, the present application is further described in detail below in conjunction with the accompanying drawings and embodiments. It should be understood that the specific embodiments described herein are only used to explain the present application and are not used to limit the present application.

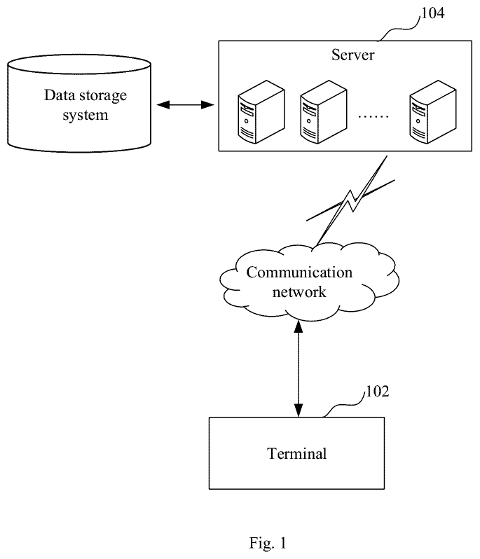

An UAV control method provided in one embodiment of the present application can be applied in an application environment shown in FIG. 1. As shown in FIG. 1, a terminal 102 communicates with a server 104 through a communication network. A data storage system can store data that the server 104 needs to process. The data storage system can be integrated on the server 104 or placed on a cloud or other network server.

Among them, the terminal 102 can be, but is not limited to, one of various UAVs, a UAV remote controller, a personal computer, a laptop, a smart phone, a tablet computer, an Internet of Things device or a portable wearable device. The Internet of Things device can be a smart speaker, a smart TV, a smart air conditioner, or a smart car-mounted device, etc. The UAV remote controller may include a somatosensory controller; the portable wearable device can be a smart watch, a smart bracelet, a head-mounted device, etc. The server 104 can be implemented by an independent server or a server cluster composed of multiple servers. The embodiments of the present disclosure can be executed by the terminal 102, by the server 104, by multiple terminals 102 respectively, or by an interaction between the terminal 102 and the server 104.

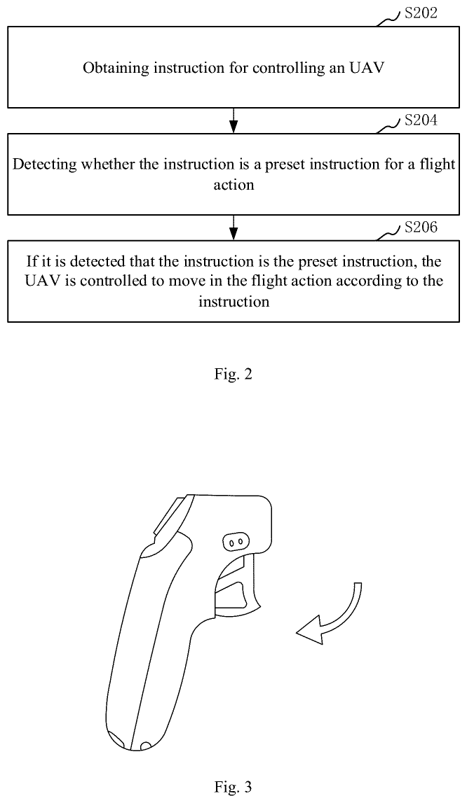

In one embodiment, as shown in FIG. 2, a method for controlling a UAV is provided, which is described by taking the method applied to the terminal 102 in FIG. 1 as an example, and includes following steps:

Step 202: obtaining an instruction for controlling an UAV.

The instruction is used to control the UAV. The instruction can be sent to the UAV via a remote controller, generated by the UAV based on data detected by the UAV, or determined based on data detected by the UAV according to certain conditions. After the conditions are met, the UAV receives the instruction sent by the remote controller. The instruction received by the UAV indicates three types of data: a pitch angle, a throttle amount, and a heading angle.

The pitch angle indicated by the instruction is used to indicate a tilt angle of the UAV relative to a certain reference plane, which is used to control whether the UAV moves in an attitude to be closer to the reference plane or in an attitude to be away from the reference plane; wherein the attitude to be closer to the reference plane is used to reduce a distance between the UAV and the reference plane, and the attitude to be away from the reference plane is used to increase the distance between the UAV and the reference plane. Exemplarily, when the reference plane is a horizontal plane, the movement in the attitude to be closer to the reference plane means that the UAV flies downward, and the movement in the attitude to be away from the reference plane means that the UAV flies upward.

The heading angle (yaw angle) indicated by the instruction is an attitude tilt angle generated in a direction different from the pitch angle, which can be in the instruction sent by the remote controller or generated by the UAV's environmental data. The heading angle is used to control the UAV's navigation direction. It can be understood that a target direction of the UAV can be calculated by positioning from different angles such as the pitch angle and the heading angle indicated by the instruction.

The throttle amount indicated by the instruction is used to indicate a driving force of the UAV, which is generated according to the throttle amount of the UAV's power source, and the driving force is used to determine an acceleration rate of the UAV. It should be understood that the throttle amount does not mean that the UAV controls the power through fuel, and the scheme of using a power source such as a hydraulic motor, an electric motor or a cylinder to control the driving force is also within the scope of protection of this application.

Step 204: detecting whether the instruction is a preset instruction for a flight action.

In one embodiment, the terminal determines parameters controlled by the throttle amount according to a control mode of the UAV. Exemplarily, when the pitch angle and the throttle amount indicated by the instruction exceed corresponding thresholds respectively, the UAV is in one control mode, and the terminal controls an attitude of the UAV according to the heading angle and the throttle amount indicated by the instruction through the throttle amount, and determines an acceleration rate of the UAV according to the throttle amount and the attitude; when the pitch angle and the throttle amount indicated by the instruction do not exceed the corresponding thresholds respectively, the UAV is in another control mode, and the terminal controls a speed and an acceleration rate of the UAV at the same time through the throttle amount.

In one embodiment, the detecting whether the instruction is a preset instruction for a flight action includes: determining whether the pitch angle and the throttle amount indicated by the instruction exceed corresponding thresholds respectively. Specifically, this step includes: determining the pitch angle according to the pitch angle instruction received by the UAV; obtaining the throttle amount according to the throttle amount instruction received by the UAV; wherein the pitch angle instruction and the throttle amount instruction are both sent through a somatosensory controller, determining whether the pitch angle exceeds a somatosensory tilt judgment threshold, and determining whether the throttle amount exceeds a throttle amount judgment threshold.

When it is detected that the pitch angle exceeds the somatosensory tilt judgment threshold and the throttle amount exceeds the throttle amount judgment threshold, it is determined that the instruction is a preset instruction for the flight action; otherwise, the instruction is not a preset instruction for the flight action.

The pitch angle is a tilt angle of the UAV relative to a reference plane when the somatosensory controller moves around an axis parallel to the reference plane. The reference plane can be a horizontal plane or other custom plane. When the somatosensory controller moves around an axis, so that a distance between one end of the somatosensory controller and the reference plane is shortened, and a distance between the other end of the somatosensory controller and the reference plane is increased, the UAV moves in an deflected attitude to be closer to the reference plane; when the somatosensory controller moves around the same direction, so that the distance between one end of the somatosensory controller and the reference plane increases, and the distance between the other end of the somatosensory controller and the reference plane is shortened, the UAV moves in an deflected attitude to be away from the reference plane; wherein, the deflected attitude to be closer to the reference plane is used to reduce the distance between the UAV and the reference plane, and the deflected attitude to be away from the reference plane is used to increase the distance between the UAV and the reference plane. Exemplarily, when one end of the somatosensory controller held by the user points downward, the UAV flies downward, as shown in FIG. 3.

Exemplarily, a direction of the somatosensory controller may be a certain coordinate axis direction of a certain coordinate system. Exemplarily, in a coordinate system established at a certain position of the somatosensory controller, x points to the front of the somatosensory controller, y points to the right of the somatosensory controller, and z points to the bottom of the somatosensory controller, and the coordinate system is shown in FIG. 4.

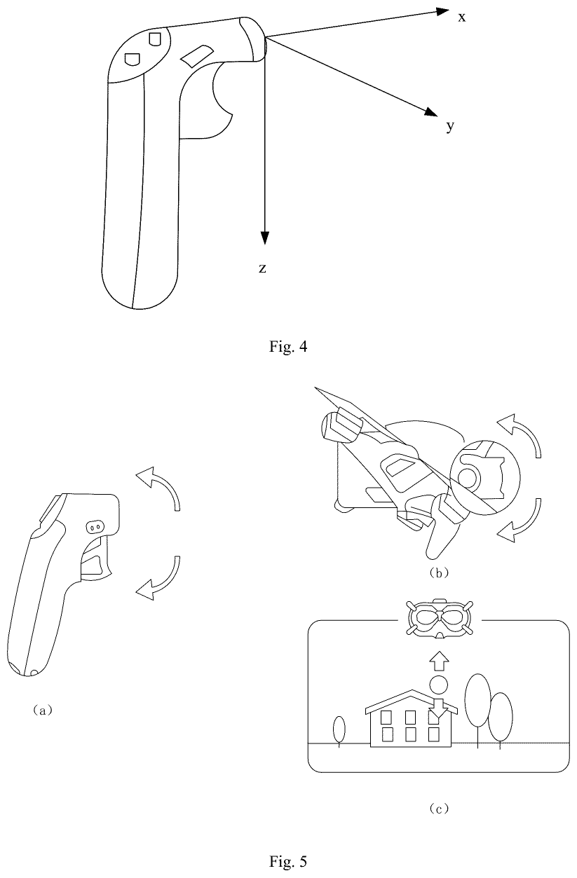

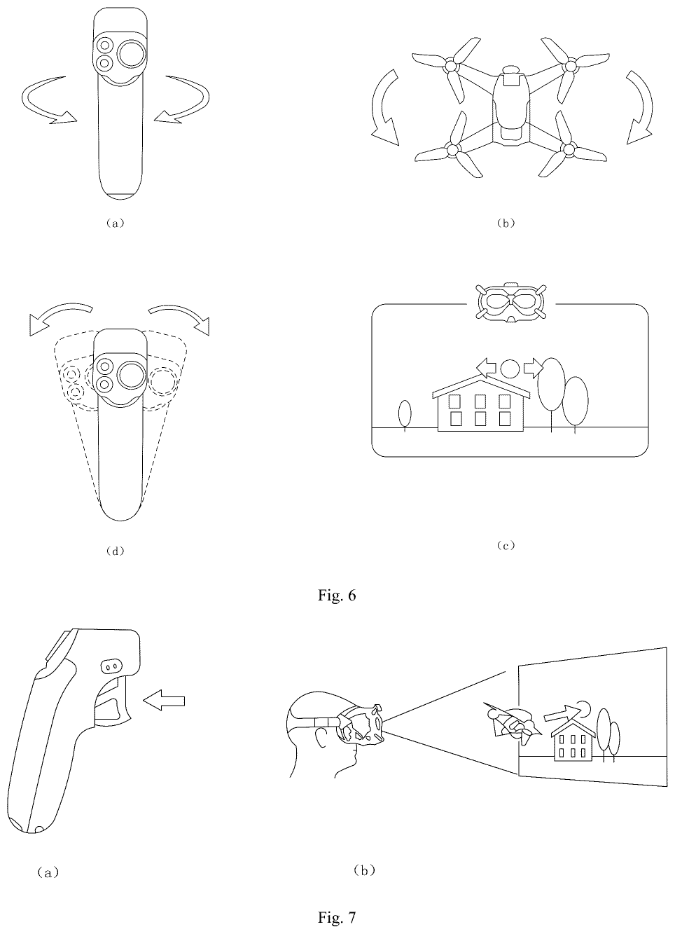

Correspondingly, when the somatosensory controller moves around the y-axis as shown in FIG. 5 (a), the pitch angle of the UAV changes as shown in FIG. 5 (b) and FIG. 5 (c); when the somatosensory controller moves around the z-axis as shown in FIG. 6 (a) or 6 (d), the heading angle of the UAV changes as shown in FIG. 6 (b) and FIG. 6 (c); when the somatosensory controller presses the throttle trigger as shown in FIG. 7 (a), the UAV moves as shown in FIG. 7 (b).

In one embodiment, the somatosensory tilt judgment threshold and the throttle amount judgment threshold can be set according to the actual flight action of a certain UAV or can be a preset value. For example, when the somatosensory tilt judgment threshold is 60° and the throttle amount judgment threshold is 0.8, the UAV can be controlled to achieve more flexible actions.

Optionally, the pitch angle is judged whether it exceeds the somatosensory tilt judgment threshold, and the throttle amount is judged whether it exceeds the throttle amount judgment threshold, and the formula is as follows:

$$\{ \begin{matrix}rc\_pitch > TRIGGER\_ANGLE \\ rc\_throttle > TRIGGER\_THROTTLE\end{matrix}$$

Among them, the pitch angle is expressed as rc_pitch, rc_pitch∈[−90°, 90°] where the pitch angle which controls the UAV to be closer to the reference plane is positive, and the somatosensory tilt judgment threshold is expressed as TRIGGER_ANGLE; the throttle amount is the throttle trigger control amount, and its range is rc_throttle∈[0,1]; the throttle judgment threshold is expressed as TRIGGER_THROTTLE, and its range is TRIGGER_THROTTLE∈(0,1).

When the pitch angle and the throttle amount exceed the corresponding thresholds, it can be judged that the instruction indicates that the movement flexibility required by the UAV is high, and the UAV can better perform the flight action according to this scheme; for example, the task completed by the UAV can be a large-scale dive action, and the large-scale dive action of the UAV can be called a “jumping action.”

Optionally, the method further includes: detecting environmental data of the UAV, performing a safety test based on the environmental data of the UAV, and executing the instruction sent by the remote controller when the UAV passes the safety test. In the process of performing a safety test based on the environmental data detected by the UAV, various types of environmental data are matched with corresponding thresholds respectively, and whether the UAV passes the safety test is determined based on the matching result of the environmental data with the corresponding thresholds, and when the UAV passes the safety test, the instruction sent by the remote controller is executed.

Step 206: If it is detected that the instruction is the preset instruction, the UAV is controlled to move in the flight action according to the instruction.

In one embodiment, that the instruction is detected to be the preset instruction, and the UAV is controlled to move in a flight action according to the instruction includes: when it is detected that the pitch angle and the throttle amount indicated by the instruction exceed the corresponding thresholds respectively, the attitude of the UAV is controlled according to the heading angle and the throttle amount indicated by the instruction; the acceleration rate of the UAV is determined according to the throttle amount and the attitude; the target direction is determined according to the pitch angle and the heading angle; and the speed of the UAV is adjusted according to the acceleration rate and the target direction, so that the UAV moves in the flight action according to the attitude and the adjusted speed.

In one embodiment, that the attitude of the UAV is controlled according to the heading angle and the throttle amount indicated by the instruction includes: determining a power direction of the UAV according to the heading angle indicated by the instruction; the power direction is used to determine a direction of acceleration rate; determining an attitude tilt angle of the UAV according to the throttle amount; and adjusting the attitude of the UAV according to the power direction and the attitude tilt angle.

The power direction of the UAV is a direction in which the driving force acts. The power direction of the UAV is used to determine the real-time direction of acceleration rate. It is understandable that when the attitude of the UAV is adjusted, the power direction of the UAV will change in real time; when the attitude of the UAV is controlled unchanged, the power direction of the UAV changes in the corresponding direction.

The power direction of a UAV is determined by the type of UAV. When the UAV is a multi-rotor UAV, the power direction is the direction in which the UAV's multi-rotors are driven together; when the UAV is a helicopter, the power direction is the direction in which the helicopter's propellers drive; when the UAV is a fixed-wing aircraft, the power direction is the direction in which lift is generated by the force of air on the wings. When the UAV is a special type of UAV, the UAV's movement is controlled according to the power source of the UAV.

The attitude tilt angle is the degree to which the attitude of the UAV changes to control the UAV to rotate to a corresponding attitude. For example, when the throttle amount is A, the attitude tilt angle is B=A*M, where M represents a mapping relationship.

In one embodiment, the adjusting the attitude of the UAV according to the power direction and the attitude tilt angle includes: adjusting the attitude of the UAV in the power direction according to the attitude tilt angle until a speed direction of the UAV is the target direction.

In one embodiment, the determining the attitude tilt angle of the UAV based on the throttle amount includes: determining a mapping relationship based on a preset throttle amount and a preset attitude tilt angle; mapping the throttle amount based on the preset attitude tilt angle and the mapping relationship to generate the attitude tilt angle of the UAV.

The preset throttle amount and the preset attitude tilt angle are respectively preset parameters. The process of presetting any parameter may be in the process of producing the UAV, and the process may also be any calculation process before determining the attitude tilt angle of the UAV according to the currently received instruction.

In one embodiment, the determining the mapping relationship based on the preset throttle amount and the preset attitude tilt angle includes: extracting feature points based on historical throttle amounts and historical attitude tilt angles; performing key point detection based on the extracted feature points, and determining the corresponding relationship between the historical throttle amounts and the historical attitude tilt angles based on the results of the key point detection; using the corresponding relationship as a mapping relationship; wherein the mapping relationship may be a linear mapping relationship or a nonlinear mapping relationship. Thus, the mapping relationship between the throttle amount and the attitude tilt angle can be calculated more accurately.

In one embodiment, the preset instruction to instruct the UAV to enter the jump mode comprise the first trigger instruction and/or the second trigger instruction, wherein the trigger device or trigger type of the first trigger instruction and the second trigger instruction are different.

For example, the first trigger instruction may be that the interaction device is triggered, and the second trigger instruction may be that the attitude information of the somatosensory controller satisfies the first preset condition. When the interaction device is triggered, it can indicate that the user expects to enter the “jumping action”. The attitude information of the somatosensory controller satisfies the first preset condition, which further indicates that the user is ready to enter the “jumping action”.

By way of example, a interactive device may be a touch screen, a touch control, that can be triggered by a touch, a button that can be triggered by a press, a toggle that can be triggered by a toggle, and the interactive device may also be an infrared sensor, a pressure sensor, a vibration sensor, and other triggering devices.”

By way of example, the first preset condition may be that the rotation angle of the somatosensory controller along one or more axes is greater than the first threshold. For example, the pitch angle at which the somatosensory controller is dropped is greater than the pitch angle threshold. The pitch angle threshold can range from 15 to 120 degrees, such as 15,20, 35, 40, 45, 50, 60, 70, 80, 90, 100, 110, 120 degrees. For example, the rotation angle of the somatosensory controller along the horizontal roller is greater than the horizontal roll angle threshold. The roll angle threshold can range from 15 to 120 degrees, such as 15, 20, 35, 40, 45, 50, 60, 70, 80, 90, 100, 110, 120 degrees. In other embodiment, the first preset condition may also be information about the rotation of the somatosensory controller about other axes, or the amount of translation of the somatosensory controller.

In some embodiment, the instruction output from the somatosensory controller may also include a third trigger instruction, control the UAV to exit the “jumping action”. The third trigger instruction may include that the interaction device is triggered and/or the posture information of the somatosensory controller satisfies the second preset condition.

By way of example, the second preset condition can be that the rotation angle of the somatosensory controller along one or more axes is greater than the second threshold. Exemplary, the second preset condition may be the same as or different from the first preset condition. for example, the second preset condition may be the same as the first preset condition with the rotation direction and threshold of the somatosensory controller. Exemplary, the second preset condition may be that the somatosensory controller rotation angle greater than a threshold along one or more axes and in a direction opposite to the first preset condition. For example, the pitch angle at which the somatosensory controller is raised is greater than the pitch angle threshold. The pitch angle threshold can range from 15 to 120 degrees, such as 15, 20, 35, 40, 45, 50, 60, 70, 80, 90, 100, 110, 120 degrees.

In one embodiment, the first preset condition may also be information about the rotation of the somatosensory controller about other axes, or the amount of translation of the somatosensory controller.

In the above embodiment, one or more axes may refer to a heading axis, a roll axis, a pitch axis.

a user double-clicks a jump button, the UAV enters a preparatory stage for jumping off a building. In this stage, the UAV hovers in place and the heading remains at the heading when it just entered the jumping mode. If a pitch angle of the motion control is less than negative 30 degrees, the UAV will enter the falling stage of the jumping mode. If it does not enter the falling stage within 5 seconds or a height from the ground is less than 40 m, it will exit the jumping mode and return to a normal fixed-point mode.

During the falling stage, the UAV falls with a roll angle of 0 degrees and a pitch angle close to −90 degrees. The user can control the falling track angle of the UAV by adjusting the pitch angle of the somatosensory controller, and can control a target yaw angle of the UAV by rotating the somatosensory controller around a z-axis under an inertial system. For example, a relationship between the target pitch heading and the UAV's target pitch attitude may be constructed based on a steady-state track angle of the UAV when it dives downward at different pitches under a certain throttle, and the total thrust of the UAV is automatically calculated by the controller, responding to the attitude control of the motion controller to maintain the dive attitude, and the user does not need to control the throttle.

Track angle: When the UAV maintains a certain pitch, yaw and thrust, the horizontal thrust and vertical thrust generated by the UAV will gradually become equivalent to the air resistance. At this time, the UAV is in a steady state and the speed reaches the maximum value. The angle between the horizontal speed and the vertical speed of the UAV is the track angle a, α=atan2(Vz,Vxy), tan(α)=Vz/Vxy.

In one embodiment, the determining the mapping relationship based on the preset throttle amount and the preset attitude tilt angle includes: determining a mapping relationship between the throttle amount and the attitude tilt angle based on difference information of different preset throttle amounts and difference information of different preset attitude tilt angles.

The difference information of different preset throttle amounts can reflect the data changes between the preset throttle amounts; and the difference information of different preset attitude tilt angles can reflect data changes between the preset attitude tilt angles, and the mapping relationship can be more clearly displayed through these two types of difference information. When one preset throttle amount is the throttle amount judgment threshold, and the other preset throttle amount is the maximum value of the throttle amount, one preset attitude tilt angle is the somatosensory tilt judgment threshold corresponding to the throttle amount judgment threshold, and the other preset attitude tilt angle is the maximum value of the attitude tilt angle corresponding to the maximum value of the throttle amount.

Exemplarily, the throttle amount judgment threshold is 0.8; the maximum throttle amount is 1, the somatosensory tilt judgment threshold corresponding to the throttle amount judgment threshold is 60°, and the maximum attitude tilt angle corresponding to the maximum throttle amount is 90°. Therefore, the difference information of different preset throttle amounts is 0.2, and the difference information of different preset attitude tilt angles is 30°.

Correspondingly, that the throttle amount is mapped according to the preset attitude tilt angle and the mapping relationship to generate the attitude tilt angle of the UAV includes: calculating the throttle amount difference information between the throttle amount and the target throttle amount; the target throttle amount is selected from one of the preset throttle amounts; according to the target attitude tilt angle and the mapping relationship, the throttle amount difference information is mapped to obtain the attitude tilt angle of the UAV; the target attitude tilt angle corresponds to the target throttle amount, and the target attitude tilt angle is selected from one of the preset attitude tilt angles.

The target throttle amount is selected from among various preset throttle amounts, and corresponds to the target attitude tilt angle. The two are used to substitute the throttle amount indicated by the instruction into the mapping relationship to calculate the attitude tilt angle corresponding to the throttle amount indicated by the instruction.

For example, the attitude tilt angle corresponding to the throttle amount is calculated using the following formula:

$$tilt\_cmd = INIT\_ANG + ( rc\_throttle - TRIGGER\_THROTTLE ) \frac{90 ° - INIT\_ANG}{1 - TRIGGER\_THROTTLE} ;$$

Among them, tilt_cmd represents the attitude tilt angle corresponding to the throttle amount indicated by the instruction, INIT_ANG represents the attitude tilt angle when the throttle amount is maximum, rc_th rottle represents the throttle amount indicated by the instruction, TRIGGER_THROTTLE represents the throttle amount judgment threshold,

$$\frac{90 ° - INIT\_ANG}{1 - TRIGGER\_THROTTLE}$$

represents the mapping relationship, (rc_throttle-TRIGGER_THROTTLE) represents the throttle amount difference information between the throttle amount indicated by the instruction and the target throttle amount.

The throttle amount of the UAV is used to determine the magnitude of the acceleration rate, while the attitude of the UAV is used to determine the direction of the acceleration rate of the UAV. When the attitude of the UAV changes in real time, the acceleration direction of the UAV also changes in real time until the attitude of the UAV remains stable.

The target direction is the direction of motion of the UAV determined by the pitch angle and the heading angle indicated by the instruction from these two angles, which is the speed direction that the UAV should reach as indicated by the instruction. For example, when the pitch angle is moving around the y-axis and the heading angle is moving around the z-axis, the pitch angle is used to control the angle of change of the UAV in at least one dimension of the x-axis and the z-axis, and the heading angle is used to control the angle of change of the UAV in at least one dimension of the x-axis and the y-axis.

In one embodiment, the terminal is a somatosensory controller. Accordingly, before determining the target direction based on the pitch angle and the heading angle, the method also includes: the somatosensory controller can obtain the attitude information of the somatosensory controller according to its own IMU and compass sensor, and convert the attitude information of the somatosensory controller according to the instructions of the somatosensory controller so that the pitch angle and the heading angle of the somatosensory controller are aligned respectively to obtain the pitch angle and the heading angle in the UAV coordinate system; the pitch angle and the heading angle in the UAV coordinate system are used to determine the target direction of the UAV.

In one embodiment, the user controls the UAV, there is usually an offset between the yaw of the motion controller held in the hand and the yaw pointed by the UAV head, that is, the motion controller points to the north, while the UAV head points to the south. The alignment operation is to calculate the target yaw in the same direction as the UAV head based on this offset: yaw_sp=yaw of the motion controller+offset, which can avoid sudden changes in the target heading of the UAV. The target pitch direction of the UAV is usually obtained by the pitch of the motion controller after travel limitation and nonlinear mapping.

In one embodiment, that the speed of the UAV is adjusted according to the acceleration rate and the target direction includes: determining whether the target direction corresponds to the direction of the current speed of the UAV; if so, maintaining the direction of the current speed according to the acceleration rate; if not, adjusting the current speed according to the acceleration rate until the direction of the current speed corresponds to the target direction.

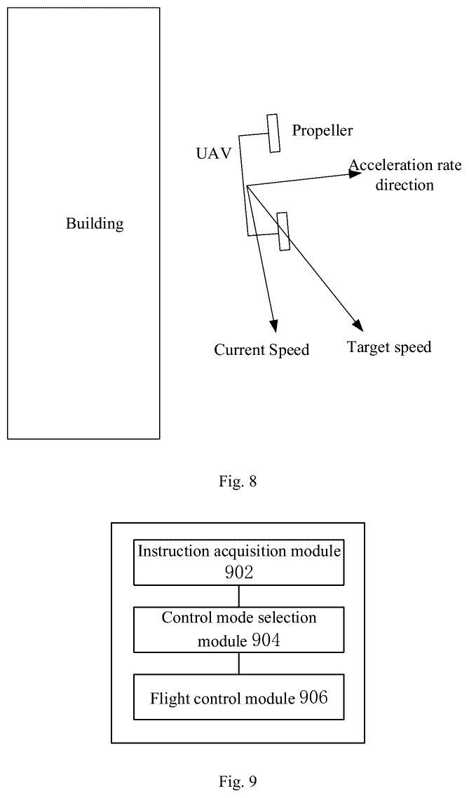

As shown in FIG. 8, the direction of the acceleration rate and the direction of the current speed of the UAV are different from the target direction. By changing the current speed of the UAV through the acceleration rate, the direction of the current speed approaches the target direction, so that the user can control the UAV more flexibly.

In one embodiment, the adjusting the current speed according to the acceleration rate until the direction of the current speed corresponds to the target direction includes: adjusting the direction of the current speed in sequence according to the acceleration rate at different moments until the direction of the current speed corresponds to the target direction at the last moment.

Optionally, before controlling the attitude of the UAV according to the heading angle and the throttle amount indicated by the instruction, the method also includes: determining whether the UAV has passed safety inspection based on environmental data of the UAV, wherein the environmental data includes one or more data of altitude, brightness, positioning data or environmental obstacles.

The altitude data is obtained by the UAV based on at least one of the data sources of the barometer or GPS, and the altitude information obtained by fusing the altitude data from multiple data sources is more accurate. Correspondingly, that according to the environmental data of the UAV, it is determined that the safety test of the UAV has passed includes: judging whether the altitude data of the UAV in the environment exceeds the corresponding altitude threshold, and when the altitude data exceeds the corresponding altitude threshold, the altitude safety test has passed.

The brightness data is obtained by detecting light intensity of the environment through a visual sensor carried by the UAV. Correspondingly, that according to the environmental data of the UAV, it is determined that the safety test of the UAV has passed includes: judging whether the brightness data of the environment in which the UAV is located is within a corresponding brightness range, which is within a daytime brightness range and can be visually identified; when the brightness data is within the corresponding brightness range, the brightness safety test has passed.

The positioning data may be at least one of quality or accuracy of the signal. The positioning data may be GPS type data. Correspondingly, that according to the environmental data of the UAV, determining whether the safety test of the UAV has passed includes: determining whether the positioning capability of the UAV in the environment exceeds a corresponding positioning threshold, and when the positioning capability exceeds the positioning threshold, the safety test of the positioning effect has passed.

Environmental obstacles are used to determine a field of view of the UAV, and the environmental obstacles are detected by the UAV's visual sensors. Correspondingly, that based on the UAV's environmental data, it is determined that the UAV's safety detection has passed includes: judging whether the obstacles in the UAV's environment are located in the UAV's expected direction of movement and distance, and when the difference between the obstacles and the UAV's expected direction of movement and distance exceeds the corresponding threshold, the safety detection of the environmental obstacles has passed. Exemplarily, when the UAV is traveling in the direction of gravity, and the distance between the obstacle in the direction of gravity and the UAV exceeds the corresponding obstacle threshold, it is determined that the obstacle's safety detection has passed; when there is an angle between the UAV's direction of movement and the direction of gravity, and the distances between the obstacle in the direction of gravity/the obstacle in the direction of movement and the UAV respectively all exceed the corresponding obstacle thresholds, it is determined that the obstacle's safety detection has passed.

In one embodiment, the method further includes: if it is determined based on the environmental data of the UAV that the safety test of the UAV has not passed, then changing the current control mode. Failure of the safety test means that it is determined that there are risk conditions that affect flight safety. Exemplarily, the determination that the safety test of the UAV has not passed includes one or more of the following conditions: the distance from the ground is less than the shortest braking distance, the distance to the monitored obstacle is less than the shortest braking distance, the GPS signal is unstable/lost, the ambient light is too dark, the power fails, or the control fails.

Optionally, the method also includes: when it is detected that the pitch angle and the throttle amount indicated by the instruction are less than corresponding thresholds, generating the heading of the UAV according to the heading angle indicated by the instruction; determining the speed of the UAV according to the pitch angle and the throttle amount to control the UAV to move according to the heading and speed.

When the pitch angle and the throttle amount indicated by the instruction are judged to be less than the corresponding thresholds, the heading angle generates the attitude of the UAV, which is used to control the navigation direction of the UAV; the pitch angle is used to control the speed direction of the UAV, whether it is level flight, upward flight or downward flight; the throttle amount is positively correlated with the speed of the UAV. Therefore, when the pitch angle and throttle amount indicated by the instruction are judged to be less than the corresponding threshold, safety is guaranteed.

In one embodiment, when it is determined that the pitch angle and the throttle amount indicated by the instruction are less than the corresponding thresholds, the formula is as follows:

$$\{ \begin{matrix}\vec{v} = f ( {rc}_{th} rottle , {rc}_{pitch} ) \\ yaw = f ( {rc}_{yaw} )\end{matrix}$$

Among them, v represents the speed of the UAV, rc_th rottle represents the throttle amount indicated by the instruction; rc_pitch represents the pitch angle indicated by the instruction; rc_yaw represents the heading angle indicated by the instruction, and yaw represents the heading direction of the UAV.

In one embodiment, the terminal is a somatosensory controller, and before generating the UAV attitude according to the heading angle indicated by the instruction, the method includes: rotating the heading angle of the UAV according to the heading angle of the somatosensory controller to change the heading angle of the UAV. Exemplarily, the initial heading angle of the UAV can be determined according to the initial position of the somatosensory controller; and the heading angle of the UAV relative to the initial heading angle can be determined based on the somatosensory rotation angle relative to the initial position.

In one embodiment, the terminal is a somatosensory controller, and before determining the speed of the UAV based on the pitch angle and the throttle amount, the method includes: mapping the pitch angle of the somatosensory controller and the throttle amount respectively to obtain the pitch angle of the UAV, and the pitch angle of the UAV is used to control the UAV to fly horizontally, upward or downward. Exemplarily, when the somatosensory controller is kept at the initial position, the flight speed of the forward flight is in the horizontal flight direction, when the somatosensory controller is lifted up: the flight speed direction of the forward flight is generated according to a somatosensory controller lifting angle; when the somatosensory controller is dropped down: the flight speed direction of the forward flight is generated according to the somatosensory downward pressure angle.

In one embodiment, the terminal is a somatosensory controller, and a throttle trigger of the somatosensory controller is used to control the forward flight speed. Specifically, when the trigger is not pulled, the flight speed instruction is 0, and the UAV automatically locks its position at this time, which can be a hovering state; when the trigger is pulled to the maximum extent, the flight speed is the maximum; when the trigger is pulled to an intermediate position: a UAV speed is mapped through a instruction mapping curve.

In the above-mentioned UAV control method, when the pitch angle and the throttle amount indicated by the instruction exceed the corresponding thresholds, a control mode is adopted to improve the flexibility of the UAV, and the attitude of the UAV is controlled according to the heading angle and the acceleration rate, so as to realize the flexible control of the acceleration direction of the UAV, and then the acceleration rate of the UAV is determined according to the throttle amount and the attitude; and the target direction is determined based on the pitch angle and the heading angle, and the speed of the UAV is adjusted according to the acceleration rate and the target direction, so as to flexibly control the final speed of the UAV, and make the flight direction of the UAV closer to the direction of the instruction through the heading angle and acceleration rate of the UAV, so as to improve the flexibility of the UAV. Even if the UAV performs a large attitude dive with an attitude exceeding a certain attitude tilt angle, the UAV can be controlled. When it is judged that the pitch angle and the throttle amount indicated by the instruction are less than the corresponding threshold values, another control mode is adopted to ensure the safety of the UAV.

In one embodiment, when it is determined that the pitch angle and throttle amount indicated by the instruction exceed the corresponding thresholds, the flexibility of the UAV controlled by this solution is demonstrated by the UAV performing a large-scale dive action. The large-scale dive means that the UAV keeps its head down and falls for a period of time, then changes its attitude to pull the UAV up and finally brakes. The attitude, the falling time, and the time to pull up the UAV can all be adjusted according to actual needs. As a result, after the flexibility of the UAV has increased, the difficulty and risk of actions such as jumping from a building with a UAV have been significantly reduced. Users can get thrilling images and flight experience through an UAV with a lower hardware price, and the control equipment is not limited. It can be realized with ordinary joystick remote control or somatosensory remote control.

It should be understood that, although the various steps in the flowcharts involved in the above-mentioned embodiments are displayed in sequence according to the indication of the arrows, these steps are not necessarily executed in sequence according to the order indicated by the arrows. Unless there is a clear explanation in this article, the execution of these steps is not strictly limited in order, and these steps can be executed in other orders. Moreover, at least a part of the steps in the flowcharts involved in the above-mentioned embodiments can include multiple steps or multiple stages, and these steps or stages are not necessarily executed at the same time, but can be executed at different times, and the execution order of these steps or stages is not necessarily carried out in sequence, but can be executed in turn or alternately with other steps or at least a part of the steps or stages in other steps.

Based on the same inventive concept, one embodiment of the present application also provides a UAV control apparatus for implementing the UAV control method involved above. The implementation solution provided by the apparatus to solve the problem is similar to the implementation solution recorded in the above method, so the specific limitations in one or more UAV control apparatus embodiments provided below can refer to the limitations of the UAV control method above, and will not be repeated here.

In one embodiment, as shown in FIG. 9, a UAV control apparatus is provided. The UAV control apparatus may include: an instruction acquisition module 902, a control mode selection module 904, and a flight control module 906, wherein:
the instruction acquisition module 902 is configured to acquire instruction for controlling the UAV;
the control mode selection module 904 is configured to detect whether the instruction is a preset instruction for a flight action; and
the flight control module 906 is configured to control the UAV to move with the flight action according to the instruction if it is detected that the instruction is the preset instruction.

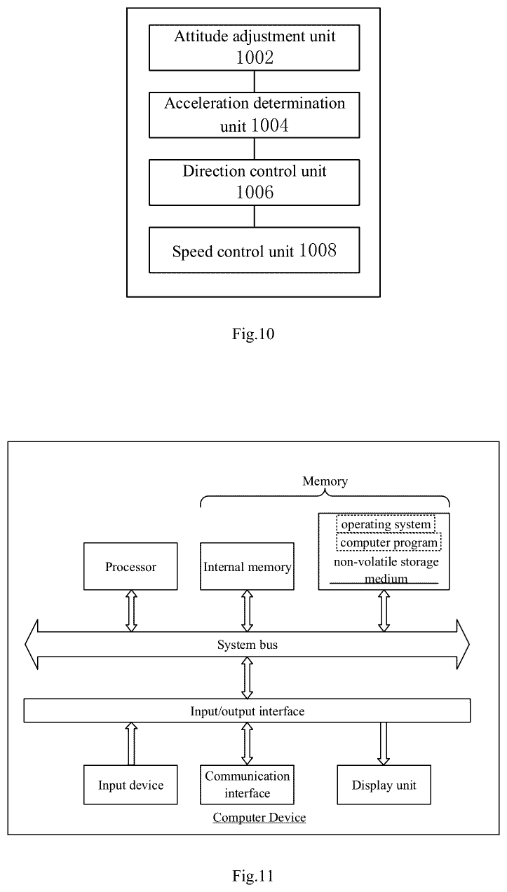

In one embodiment, as shown in FIG. 10, the flight control module 906 includes: an attitude adjustment unit 1002, an acceleration determination unit 1004, a direction control unit 1006, and a speed control unit 1008.

The attitude adjustment unit 1002 is configured to control an attitude of the UAV according to the heading angle and the throttle amount indicated by the instruction when detecting whether the pitch angle and the throttle amount indicated by the instruction exceed corresponding thresholds.

The acceleration determination unit 1004 is configured to determine an acceleration rate of the UAV according to the throttle amount and the attitude.

The direction control unit 1006 is configured to determine a target direction based on the pitch angle and the heading angle.

The speed control unit 1008 is configured to adjust a speed of the UAV according to the acceleration rate and the target direction, so that the UAV performs the flight action according to the attitude and the adjusted speed.

In one embodiment, the attitude adjustment unit 1002 is configured to:
determine a power direction of the UAV according to the heading angle indicated by the instruction; the power direction is configured to determine a direction of the acceleration rate;
determine an attitude tilt angle of the UAV according to the throttle amount; and
control an attitude of the UAV according to the power direction and the attitude tilt angle.

In one embodiment, the attitude adjustment unit 1002 is configured to:
determine a mapping relationship based on a preset throttle amount and a preset attitude tilt angle; and
map the throttle amount to generate the attitude tilt angle of the UAV according to the preset attitude tilt angle and the mapping relationship.

In one embodiment, the attitude adjustment unit 1002 is specifically configured to:
determine a mapping relationship between the throttle amount and the attitude tilt angle based on difference information of different preset throttle amounts and difference information of different preset attitude tilt angles;
calculating throttle amount difference information between the throttle amount and a target throttle amount; the target throttle amount is selected from one of the preset throttle amounts; and
map the throttle amount difference information to obtain the attitude tilt angle of the UAV according to the target attitude tilt angle and the mapping relationship; the target attitude tilt angle corresponds to the target throttle amount, and the target attitude tilt angle is selected from one of the preset attitude tilt angles.

In one embodiment, the control mode selection module 904 is configured to:
determine a pitch angle according to the pitch angle instruction received by the UAV;
obtain a throttle amount according to a throttle amount instruction received by the UAV; wherein the pitch angle instruction and the throttle amount instruction are both sent via a somatosensory controller;
determine whether the pitch angle exceeds a somatosensory tilt judgement threshold, and determine whether the throttle amount exceeds a throttle amount judgement threshold.

In one embodiment, the speed control unit 1008 is configured to:
determine whether the target direction corresponds to the direction of the current speed of the UAV;
if so, maintain the direction of the current speed according to the acceleration rate;
if not, adjust the current speed according to the acceleration rate until the direction of the current speed corresponds to the target direction.

In one embodiment, the control mode selection module 904 is further configured to:
determine, based on environmental data of the UAV, that the UAV passes a safety inspection, wherein the environmental data includes one or more of altitude, brightness, positioning data or environmental obstacles.

In one embodiment, the direction control unit 1006 is configured to generate the heading direction of the UAV according to the heading angle indicated by the instruction when it is detected that the pitch angle and the throttle amount indicated by the instruction are less than corresponding threshold values.

Correspondingly, the speed control unit 1008 is configured to determine the speed of the UAV according to the pitch angle and the throttle amount, so as to control the UAV to move according to the heading direction and the speed.

The above-mentioned UAV control apparatus can be implemented in whole or in part by software, hardware, or a combination thereof. Each of the above-mentioned modules can be embedded in or independent of a processor in a computer device in the form of hardware, or can be stored in a memory in a computer device in the form of software, so that the processor can call and execute operations corresponding to each of the above modules.

In one embodiment, a computer device is provided, which may be a terminal, and its internal structure diagram may be shown in FIG. 11. The computer device includes a processor, a memory, an input/output interface, a communication interface, a display unit, and an input device. The processor, the memory, and the input/output interface are connected via a system bus, and the communication interface, the display unit, and the input device are connected to the system bus via the input/output interface. The processor of the computer device is used to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The input/output interface of the computer device is used to exchange information between the processor and an external device. The communication interface of the computer device is used to communicate with an external terminal in a wired or wireless manner, and the wireless manner can be implemented through WIFI, a mobile cellular network, NFC (near field communication) or other technologies. When the computer program is executed by the processor, a method for controlling a UAV is implemented. The display unit of the computer device is used to form a visually visible image, and can be a display screen, a projection device or a virtual reality imaging device. The display screen can be a liquid crystal display screen or an electronic ink display screen. The input device of the computer device can be a touch layer covered on the display screen, or a button, trackball or touchpad set on the computer device casing, or an external keyboard, touchpad or mouse, etc.

Those skilled in the art will understand that the structure shown in FIG. 11 is merely a block diagram of a partial structure related to the scheme of the present application, and does not constitute a limitation on the computer device to which the scheme of the present application is applied. The specific computer device may include more or fewer components than shown in the figure, or combine certain components, or have a different arrangement of components.

In one embodiment, a computer device is further provided, including a memory and a processor, wherein a computer program is stored in the memory, and the processor implements the steps in the above method embodiments when executing the computer program.

In one embodiment, a computer-readable storage medium is provided, on which a computer program is stored. When the computer program is executed by a processor, the steps in the above-mentioned method embodiments are implemented.

In one embodiment, a computer program product is provided, including a computer program, which implements the steps in the above method embodiments when executed by a processor.

It should be noted that the user information (including but not limited to user device information, user personal information, etc.) and data (including but not limited to data used for analysis, stored data, displayed data, etc.) involved in this application are all information and data authorized by the user or fully authorized by all parties, and the collection, use and processing of relevant data must comply with relevant laws, regulations and standards of relevant countries and regions.

A person of ordinary skill in the art can understand that all or part of the processes in the above-mentioned embodiment method can be completed by instructing the relevant hardware through a computer program, and the computer program can be stored in a non-volatile computer-readable storage medium. When the computer program is executed, it can include the processes of the embodiments of the above-mentioned methods. Among them, any reference to the memory, database or other medium used in the embodiments provided in the present application can include at least one of non-volatile and volatile memory. Non-volatile memory can include read-only memory (ROM), magnetic tape, floppy disk, flash memory, optical memory, high-density embedded non-volatile memory, resistive random access memory (ReRAM), magnetic random access memory (MRAM), ferroelectric random access memory (FRAM), phase change memory (PCM), graphene memory, etc. Volatile memory can include random access memory (RAM) or external cache memory, etc. As an illustration and not limitation, RAM can be in various forms, such as static random access memory (SRAM) or dynamic random access memory (DRAM). The database involved in each embodiment provided in this application may include at least one of a relational database and a non-relational database. Non-relational databases may include distributed databases based on blockchains, etc., but are not limited to this. The processor involved in each embodiment provided in this application may be a general-purpose processor, a central processing unit, a graphics processor, a digital signal processor, a programmable logic unit, a data processing logic unit based on quantum computing, circuitry, etc., but are not limited to this.

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A method for controlling an unmanned aerial vehicle (UAV), comprising:
obtaining an instruction for controlling the UAV;
detecting that the instruction is a preset instruction for a flight action; and
controlling the UAV to move in the flight action according to the preset instruction,
wherein the instruction includes a first instruction configured to control the UAV to perform a dive action in a diving attitude autonomously or a second instruction configured to control the UAV to perform the dive action according to a received direction control instruction.

2. The method according to claim 1, wherein the detecting that the instruction is the preset instruction for the flight action, and controlling the UAV to move in the flight action according to the preset instruction comprises:
detecting that a pitch angle and a throttle amount indicated by the instruction exceed a pitch angle threshold and a throttle amount threshold respectively;
controlling an attitude of the UAV according to a heading angle and the throttle amount indicated by the instruction;
determining an acceleration rate of the UAV according to the throttle amount and the attitude;
determining a target direction based on the pitch angle and the heading angle;
adjusting a speed of the UAV according to the acceleration rate and the target direction to obtain an adjusted speed of the UAV; and
controlling the UAV to perform the flight action according to the attitude and the adjusted speed.

3. The method according to claim 2, wherein the controlling the attitude of the UAV according to the heading angle and the throttle amount indicated by the instruction comprises:
determining a power direction of the UAV according to the heading angle indicated by the instruction; the power direction configured to determine a direction of the acceleration rate;
determining an attitude tilt angle of the UAV according to the throttle amount; and
control the attitude of the UAV according to the power direction and the attitude tilt angle.

4. The method according to claim 3, wherein the determining the attitude tilt angle of the UAV according to the throttle amount comprises:
determining a mapping relationship based on a preset throttle amount and a preset attitude tilt angle; and
map the throttle amount to generate the attitude tilt angle of the UAV according to the preset attitude tilt angle and the mapping relationship.

5. The method according to claim 4, wherein the determining the mapping relationship based on the preset throttle amount and the preset attitude tilt angle comprises:
determining difference information of different preset throttle amounts;
determining difference information of different preset attitude tilt angles; and
determining the mapping relationship between the throttle amount and the attitude tilt angle based on the difference information of different preset throttle amounts and the difference information of different preset attitude tilt angles;
wherein the mapping the throttle amount to generate the attitude tilt angle of the UAV according to the preset attitude tilt angle and the mapping relationship includes:
calculating throttle amount difference information between the throttle amount and a target throttle amount, the target throttle amount selected from one of the preset throttle amounts; and
mapping the throttle amount difference information to obtain the attitude tilt angle of the UAV according to the target attitude tilt angle and the mapping relationship,
wherein the target attitude tilt angle corresponds to the target throttle amount, and the target attitude tilt angle is selected from one of the preset attitude tilt angles.

6. The method according to claim 1, wherein the obtaining the instruction for controlling the UAV and detecting that the instruction is the preset instruction for the flight action comprises:
receiving the instruction transmitted from a somatosensory controller, the instruction including a pitch angle instruction and/or a throttle amount instruction;
determining the pitch angle according to the pitch angle instruction received by the UAV;
determining the throttle amount according to the throttle amount instruction received by the UAV;
detecting that the pitch angle exceeds a somatosensory tilt judgement threshold, and that the throttle amount exceeds a throttle amount judgement threshold.

7. The method according to claim 2, wherein the adjusting the speed of the UAV according to the acceleration rate and the target direction comprises:
determining whether the target direction corresponds to a direction of a current speed of the UAV;
if yes, maintaining the direction of the current speed according to the acceleration rate; and
if no, adjusting the current speed according to the acceleration rate until the direction of the current speed corresponds to the target direction.

8. The method according to claim 1, wherein, before controlling the UAV to move in the flight action according to the preset instruction, the method further comprises:
determining that the UAV passes a safety inspection based on environmental data of the UAV,
wherein the environmental data includes one or more of altitude, brightness, positioning data or environmental obstacles.

9. The method according to claim 1, wherein the instruction comprises the second instruction configured to control the UAV to perform the dive action according to the received direction control instruction, and
wherein the controlling the UAV to move in the flight action according to the preset instruction comprises:
controlling the UAV to enter an jumping action.

10. The method according to claim 9, wherein the preset instruction comprises the first trigger instruction and/or a second trigger instruction, wherein trigger devices or trigger types of the first trigger instruction and the second trigger instruction are different.

11. The method according to claim 9, wherein
the first trigger instruction represents an interaction device is touched, dropped, or toggle;
and/or the second trigger instruction represents the pitch angle at which the somatosensory controller is dropped is greater than the first threshold.

12. The method according to claim 9, wherein the method further comprises:
control the UAV to exit the jumping action when receiving a third trigger instruction; wherein the third trigger instruction represents the pitch angle at which the somatosensory controller is raised is greater than the second threshold.

13. The method according to claim 1, wherein the instruction comprises the second instruction configured to control the UAV to perform the dive action according to the received direction control instruction, and
wherein the controlling the UAV to move in the flight action according to the preset instruction comprises:
controlling an attitude of the UAV to flip along a first axis so that the UAV enters the diving attitude; and
controlling the attitude and/or flight direction of the UAV to move in the dive action according to the received direction control instruction,
wherein a magnitude of a descending acceleration of the UAV along a direction of gravity is related to the attitude and the flight direction of the UAV.

14. The method according to claim 13, wherein during moving in the dive action, the UAV is shielded from the throttle instruction.

15. The method according to claim 13, wherein the controlling the attitude and/or flight direction of the UAV to move in the dive action according to the received direction control instruction comprises:
determining a target direction according to a pitch angle information of a somatosensory controller; and
controlling a nose of the UAV to face the target direction according to the target direction and a current flight direction of the UAV.

16. The method according to claim 13, wherein during moving in the dive action, a thrust generated by the UAV offsets at least a part of an air disturbance torque to maintain the attitude or orientation of the UAV.

17. The method according to claim 13, wherein the descending acceleration of the UAV along the direction of gravity is negatively correlated to a speed of the UAV along the direction of gravity.

18. The method according to claim 13, wherein the first axis is one of a yaw axis, a pitch axis, or a roll axis; and/or
in the diving attitude, an angle between the direction of gravity and a thrust direction generated by a power assembly of the UAV is greater than or equal to 60 degrees.

19. A UAV, comprising:
a power assembly; and
one or more processors, operating individually or in coordination, configured to control an operation of the power assembly to:
control an attitude of the UAV to flip along a first axis so that the UAV enters a diving attitude; and
control the attitude and/or flight direction of the UAV to move in a dive action according to a received direction control instruction,
wherein a magnitude of a descending acceleration of the UAV along a direction of gravity is related to the attitude and the flight direction of the UAV, and during moving in the dive action, the UAV is shielded from the throttle instruction.

20. The method according to claim 19, wherein the instruction comprises the second instruction configured to control the UAV to perform the dive action according to the received direction control instruction, and
wherein the controlling the UAV to move in the flight action according to the preset instruction comprises:
controlling the UAV to enter an jumping action.

21. The method according to claim 20, wherein the preset instruction comprises a first trigger instruction and/or a second trigger instruction, wherein
the first trigger instruction represents that the interaction device is touched, dropped, or toggle;
and/or the second trigger instruction represents the pitch angle at which the somatosensory controller is dropped is greater than the first threshold.

22. The method according to claim 20, wherein the method further comprises:
control the UAV to exit the jumping action when receiving a third trigger instruction; wherein the third trigger instruction represents the pitch angle at which the somatosensory controller is raised is greater than the second threshold.

23. The UAV according to claim 19, wherein the controlling the attitude and/or flight direction of the UAV to move in the dive action according to the received direction control instruction comprises:
determining a target direction according to a pitch angle information of a somatosensory controller; and
controlling a nose of the UAV to face the target direction according to the target direction and the current flight direction of the UAV.

24. The UAV according to claim 19, wherein during moving in the dive action, a thrust generated by the UAV offsets at least a part of an air disturbance torque to maintain the attitude or orientation of the UAV.

25. The UAV according to claim 19, wherein the descending acceleration of the UAV along the direction of gravity is negatively correlated to a speed of the UAV along the direction of gravity.

26. A somatosensory controller, comprising
an attitude sensor configured to obtain an attitude of the somatosensory controller; and
one or more processors, operating individually or in coordination, configured to control an UAV to:
control an attitude of the UAV to flip along a first axis so that the UAV enters a diving attitude; and
control the attitude and/or flight direction of the UAV to move in a dive action according to a received direction control instruction,
wherein a magnitude of a descending acceleration of the UAV along a direction of gravity is related to the attitude and the flight direction of the UAV, and during moving in the dive action, the UAV is shielded from the throttle instruction.

27. The somatosensory controller according to claim 26, wherein the instruction comprises the second instruction configured to control the UAV to perform the dive action according to the received direction control instruction, and
wherein the controlling the UAV to move in the flight action according to the preset instruction comprises:
controlling the UAV to enter an jumping action.

28. The somatosensory controller according to claim 27, wherein the somatosensory controller further comprises:
an interaction device, connected to the processors;
wherein the processors configured to
sent the instruction to control the UAV to enter an jumping action when the interaction device is touched, dropped or toggle, and the attitude sensor represent the pitch angle at which the somatosensory controller is dropped is greater than the first threshold.

29. The somatosensory controller according to claim 27, wherein the processors configured to:
control the UAV to exit the jumping action when receiving a third trigger instruction; wherein the third trigger instruction represents the pitch angle at which the somatosensory controller is raised is greater than the second threshold.

30. The somatosensory controller according to claim 19, wherein the instruction comprises the second instruction configured to control the UAV to perform the dive action according to the received direction control instruction, and
wherein the controlling the UAV to move in the flight action according to the preset instruction comprises:
controlling an attitude of the UAV to flip along a first axis so that the UAV enters the diving attitude; and
controlling the attitude and/or flight direction of the UAV to move in the dive action according to the received direction control instruction,
wherein a magnitude of a descending acceleration of the UAV along a direction of gravity is related to the attitude and the flight direction of the UAV.
